(19) United States
(12) Patent Application Publication
(10) Pub. No.: US 2011/0004469 A1
(43) Pub. Date: Jan. 6, 2011

(54) VECTOR QUANTIZATION DEVICE, VECTOR INVERSE QUANTIZATION DEVICE, AND METHOD THEREOF

(75) Inventors: Kaoru Sato, Kanagawa (JP); Toshiyuki Morii, Kanagawa (JP); Tomofumi Yamanashi, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/445,812

(22) PCT Filed: Oct. 16, 2007
(86) PCT No.: PCT/JP2007/070178

§ 371 Date: Apr. 16, 2009

(30) Foreign Application Priority Data
Oct. 17, 2006 (JP) 2006-283097

(51) Int. Cl. G10L 19/12; G10L 21/00

(52) U.S. Cl. 704/219; 704/222; 704/223; 704/E19.025; 704/E19.026

(57) ABSTRACT

Disclosed are a vector quantization device and others capable of adaptively adjusting a vector space of a code vector for quantization of a second stage by using a quantization result of a first stage and improving the quantization accuracy. In the device, the first quantization unit (101) performs quantization of an LSP vector; a quantization residual difference generation unit (102) acquires a residual difference between the LSP vector and the first quantization vector obtained by the first quantization unit (101) as a quantization residual difference vector; an addition factor selection unit (103) selects one of the addition factor code vectors in an addition factor codebook as an addition factor vector according to the first code obtained by the first quantization unit (101); an addition residual difference generation unit (104) acquires a residual difference between the quantization residual difference vector and the addition factor vector as an addition residual vector; and a second quantization unit (105) performs quantization of the addition residual difference vector.

### TECHNICAL FIELD

The present invention relates to a vector quantization apparatus, vector dequantization apparatus, and vector quantization and dequantization methods for vector-quantization of LSP (Line Spectral Pairs) parameters. In particular, the present invention relates to a vector quantization apparatus, vector dequantization apparatus, and vector quantization and dequantization method for vector-quantization of LSP parameters that are used in a speech encoding and decoding apparatus that transmits speech signals in fields of, particularly, a packet communication system represented by Internet communication and a mobile communication system.

### BACKGROUND ART

In the field of digital wireless communication, packet communication represented by Internet communication and speech storage, speech signal encoding and decoding techniques are essential for effective use of the channel capacity of radio waves and storage media. In particular, a CELP speech encoding and decoding technique is a mainstream technique (for example, see non-patent document 1).

A CELP speech encoding apparatus encodes input speech based on pre-stored speech models. To be more specific, the CELP (Code Excited Linear Prediction) speech encoding apparatus separates a digital speech signal into frames of regular time intervals, for example, frames of approximately 10 to 20 ms, performs a linear prediction analysis of a speech signal on a per frame basis, finds the linear prediction coefficients (“LPC's”) and linear prediction residual vector, and encodes the linear prediction coefficients and linear prediction residual vector individually. As a method of encoding linear prediction coefficients, a CELP speech encoding apparatus generally adopts a method of converting the linear prediction coefficients into LSP parameters and encoding these LSP parameters. As a method of encoding LSP parameters, a CELP speech encoding apparatus oftentimes performs vector quantization of LSP parameters. As a method of vector quantization, to reduce the amount of calculations in vector quantization, multistage vector quantization is used oftentimes (e.g., see Non-Patent Document 2). Multistage vector quantization is a method of quantizing a vector to be quantized, over a plurality of stages. For example, by further quantizing early-stage quantization error in the later stages, it is possible to improve the accuracy of vector quantization.
Non-Patent Document 1: M. R. Schroeder, B. S. Atal, “Code Excited Linear Prediction: High Quality Speech at Low Bit Rate,” IEEE proc., ICASSP, 1985, p. 937-940
Non-Patent Document 2: Allen Gersho, Robert M. Gray, translated by Yoshii and other three people, “Vector Quantization and Signal Compression,” Corona Publishing Co., Ltd, 10 Nov. 1998, pages 524 to 531

### DISCLOSURE OF INVENTION

### Problem to be Solved by the Invention

However, although the above-noted multistage vector quantization is an efficient method to enable more LSP vectors and code vectors to be matched with a smaller amount of calculations, matching in each stage is performed with respect to one candidate, and, consequently, the performance is not sufficient. To improve performance, although it is possible to adopt a method of leaving a plurality of candidates in the first stage and performing a search using these candidates in the second stage, there is a problem that the amount of calculations increases.

It is therefore an object of the present invention to provide a vector quantization apparatus, vector dequantization apparatus, and vector quantization and dequantization methods that can perform vector quantization in the later stages based on the vector quantization result in the early stage in multistage vector quantization and improve quantization accuracy with a smaller amount of calculations and lower bit rate.

### Means for Solving the Problem

The vector quantization apparatus of the present invention employs a configuration having: a first quantization section that comprises a first codebook, quantizes an input vector to generate a first code and first quantization vector; a quantization residual generating section that generates a residual between the vector and the first quantization vector, as a quantization residual vector; an additive factor selecting section that comprises an additive factor codebook and selects an additive factor vector associated with the first code from the additive factor codebook; an additive residual generating section that generates a residual between the first quantization vector and the additive factor vector, as an additive residual vector; and a second quantization section that comprises a second codebook, quantizes the additive residual vector to generate a second code.

The vector dequantization apparatus of the present invention employs a configuration having: a first dequantization section that comprises a first codebook, dequantizes a first code acquired from a received quantized vector code to generate a first quantization vector; a second dequantization section that comprises a second codebook, dequantizes a second code acquired from the quantized vector code to generate a quantization additive residual vector; an additive factor selecting section that comprises an additive factor codebook and selects an additive factor vector associated with the first code from the additive factor codebook; a quantization residual generating section that generates a quantization residual vector by adding the quantization additive residual vector and the additive factor vector; and a quantization vector generating section that generates a quantized vector by adding the first quantization vector and the quantization residual vector.

### Advantageous Effect of the Invention

According to the present invention, a vector is quantized in a plurality of stages, and the vector space of code vectors to be used for quantization in the later stages is adjusted adaptively based on a quantization result in the early stage, so that it is possible to improve quantization accuracy with a smaller amount of calculations and lower bit rate.

### BRIEF DESCRIPTION OF DRAWINGS

FIG. 1 is a block diagram showing main components of an LSP vector quantization apparatus according to Embodiment 1;

FIG. 2 is a block diagram showing main components of an LSP vector dequantization apparatus according to Embodiment 1;

FIG. 3 illustrates a state where the vector space of second code vectors is adaptively adjusted using an additive factor vector associated with a quantization result in a first quantization section according to Embodiment 1;

FIG. 4 is a block diagram showing main components of an LSP vector quantization apparatus according to Embodiment 2;

FIG. 5 is a block diagram showing main components of an LSP vector dequantization apparatus according to Embodiment 2;

FIG. 6 illustrates a state where the vector space of a second code vector is adaptively adjusted using additive factor vectors associated with a quantization result in a first quantization section according to Embodiment 2;

FIG. 7 is a block diagram showing main components of an LSP vector quantization apparatus according to Embodiment 3;

FIG. 8 is a block diagram showing main components of an LSP vector dequantization apparatus according to Embodiment 3;

FIG. 9 is a block diagram showing main components of a CELP encoding apparatus according to Embodiment 9; and

FIG. 10 is a block diagram showing main components of a CELP decoding apparatus according to Embodiment 4.

### BEST MODE FOR CARRYING OUT THE INVENTION

Embodiments of the present invention will be explained below in detail with reference to the accompanying drawings. Further, an example will be explained where an LSP vector quantization apparatus, LSP vector dequantization apparatus, and quantization method and dequantization methods are used as the vector quantization apparatus, vector dequantization apparatus, and quantization and dequantization methods according to the present invention.

Further, a vector of LSP (Line Spectral Pairs) parameters is abbreviated to “LSP vector.” Further, in the present invention, a factor (vector) to move the centroid that is the center of a code vector space by addition or subtraction with respect to all code vectors forming a codebook, is referred to as “additive factor.” Further, actually, it is more likely to subtract an additive factor vector from the vector of the quantization target for use, rather than add an additive factor vector to a code vector for use. Further, this residual (vector) that is a result of subtracting an additive factor vector from the vector of the quantization target is referred to as “additive residual.”

### Embodiment 1

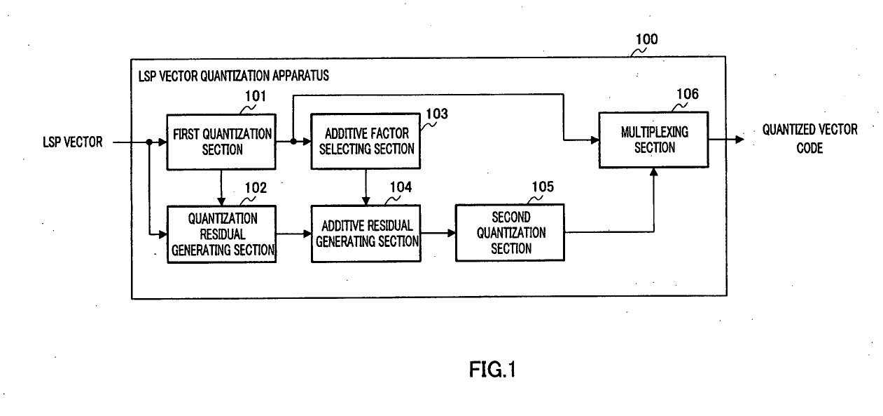

FIG. 1 is a block diagram showing main components of LSP vector quantization apparatus 100 according to the present embodiment. An example case will be explained where an input LSP vector is quantized, the residual in the vector quantization is predicted using the acquired quantization result, and, furthermore, this predicted error is quantized.

LSP vector quantization apparatus 100 is provided with first quantization section 101, quantization residual generating section 102, additive factor selecting section 103, additive residual generating section 104, second quantization section 105 and multiplexing section 106.

First quantization section 101 incorporates a first codebook comprised of a plurality of first code vectors, and quantizes an inputted LSP vector using the built-in first codebook, calculates the first quantization vector and first code, outputs the first code to additive factor selecting section 103 and multiplexing section 106, and outputs the first quantization vector to quantization residual generating section 102.

Quantization residual generating section 102 calculates the residual between the input LSP vector and the first quantization vector received as input from first quantization section 101, and outputs the calculated residual to additive residual generating section 104 as a quantization residual vector.

Additive factor selecting section 103 incorporates an additive factor codebook comprised of a plurality of additive factor code vectors, and, based on the first code received as input from first quantization section 101, selects one additive factor code vector from the additive factor codebook. Additive factor selecting section 103 outputs the selected additive factor code vector to additive residual generating section 104 as an additive factor vector.

Additive residual generating section 104 calculates the residual between the quantization residual vector received as input from quantization residual generating section 102 and the additive factor vector received as input from additive factor selection 103, and outputs the calculated residual to second quantization section 105 as an additive residual vector.

Second quantization section 105 incorporates a second codebook comprised of a plurality of second code vectors, and quantizes the additive residual vector received as input from additive residual generating section 104 using the built-in second codebook and outputs the resulting second code to multiplexing section 106.

Multiplexing section 106 multiplexes the first code received as input from first quantization section 101 and the second code received as input from second quantization section 105, and outputs the resulting code as a quantized vector code.

The operations of LSP vector quantization apparatus 100 will be explained below with an example case where the order of the LSP vector of the quantization target is R. Further, an LSP vector is expressed as LSP(i) (i=0, 1, . . . , R-1).

First quantization section 101 calculates the square error between an inputted LSP vector LSP(i) (i=0, 1, . . . , R-1) and each first code vector CODE_P^{(m)}(i) (m=0, 1, . . . , M-1, i=0, 1, . . . , R-1) forming the built-in first codebook, according to following equation 1.

$${Err\_P}^{( m )} = {\sum }_{i = 0}^{R - 1} {( LSP ( i ) - {CODE\_P}^{( m )} ( i ) )}^{2} \qquad ( Equation 1 )$$

Here, m is the index of each first code vector forming the first codebook, and M is the total number of the first code vectors forming the first codebook. First quantization section 101 outputs the value m_min of m where the square error Err_P^{(m)} is minimum amongst the resulting square errors Err_P^{(m)} (m=0, 1, . . . , M-1) associated with the M first code vectors, to additive factor selecting section 103 and multiplexing section 106 as a first code. Further, the first code vector CODE_P^{(m}^{_{—}}^{min)}(i) (i=0, 1, . . . , R-1) minimizing the square error Err_P^{(m)} is outputted to quantization residual generating section 102 as a first quantization vector. That is, first quantization section 101 selects the first code vector where the similarity is maximized between the first code vector and the LSP vector, from the first codebook.

Quantization residual generating section 102 calculates the residual ERR(i) (i=0, 1, . . . , R-1) between the input LSP vector LSP(i) (i=0, 1, . . . , R-1) and the first quantization vector CODE_P^{(m}^{_{—}}^{min)}(i) (i=0, 1, . . . , R-1) received as input from first quantization section 101, according to following equation 2.

ERR(i)=LSP(i)−CODE_{—}P(m^{_{—}}^{min)}(i) (i=0, . . . , R-1) (Equation 2)

Quantization residual generating section 102 outputs the calculated ERR(i) (i=0, 1, . . . , R-1) to additive residual generating section 104 as a quantization residual vector.

Additive factor selecting section 103 selects the additive factor code vector ADD_F^{(m}^{_{—}}^{min)}(i) (i=0, 1, . . . , R-1) associated with the first code m_min received as input from first quantization section 101, from the additive factor code vectors ADD_F^{(m)}(i) (m=0, 1, . . . , M-1, i=0, 1, . . . , R-1) forming the built-in additive factor codebook. Here, the additive factor codebook is comprised of M code vectors, and the additive factor code vectors forming the additive factor codebook are associated with the first code vectors forming the first codebook in one-to-one association. An additive factor code vector is a scalar or a vector for adaptively adjusting the vector space of the second code vector based on the first code which is a quantization result in first quantization section 101. To be more specific, the additive factor code vector is acquired by predicting the residual between the first quantization vector and the LSP vector, based on the first code. That is, the additive factor code vector selected from the additive factor codebook by additive factor selecting section 103 is one additive factor code vector among M additive factor code vectors forming the additive factor codebook, where the similarity is maximized between the additive factor codebook vector and the quantization residual vector generated in quantization residual generating section 102. Additive factor selecting section 103 outputs the selected additive factor code vector ADD_F^{(m}^{_{—}}^{min)}(i) (i=0, 1, . . . , R-1) to additive residual generating section 104 as an additive factor vector.

Additive residual generating section 104 calculates the residual A_ERR(i) (i=0, 1, . . . , R-1) between the quantization residual vector ERR(i) (i=0, 1, . . . , R-1) received as input from quantization residual generating section 102 and the additive factor vector ADD_F^{(m}^{_{—}}^{min)}(i) (i=0, 1, . . . , R-1) received as input from additive factor selecting section 103, according to following equation 3.

A_ERR(i)=ERR(i)−ADD_{—}F^{(m}^{_{—}}^{min)}(i) (i=0, . . . , R-1) (Equation 3)

Additive residual generating section 104 outputs the calculated A_ERR(i) (i=0, 1, . . . , R-1) to second quantization section 105 as an additive residual vector.

Second quantization section 105 calculates the square error Err_F⁽ⁿ⁾ (n=0, 1, . . . , N−1) between the additive residual vector A_ERR(i) (i=0, 1, . . . , R-1) received as input from additive residual generating section 104 and each second code vector CODE_F⁽ⁿ⁾(i) (i=0, 1, . . . , R-1, n=0, 1, . . . , N-1) forming the built-in second codebook, according to following equation 4.

$${Err\_F}^{( n )} = {\sum }_{i = 0}^{R - 1} {( A\_ERR ( i ) - {CODE\_F}^{( n )} ( i ) )}^{2} \qquad ( Equation 4 )$$

Here, n is the index of each second code vector forming the second codebook, and N is the total number of second code vectors forming the second codebook. Second quantization section 105 outputs the value n_min of n where the square error Err_F⁽ⁿ⁾ is minimum amongst N square errors Err_F⁽ⁿ⁾ (n=0, 1, . . . , N-1) calculated, to multiplexing section 106 as a second code. That is, second quantization section 105 selects the second code vector from the second codebook, where the similarity is maximized between the second code vector and the additive residual vector.

Multiplexing section 106 multiplexes the first code m_min received as input from first quantization section 101 and the second code n_min received as input from second quantization section 105, and transmits the resulting quantized vector code to LSP vector dequantization apparatus 150.

The first codebook, additive factor codebook and second codebook used in LSP vector quantization apparatus 100 are prepared and created in advance by learning, and the method of learning these codebooks will be explained.

To prepare the first codebook included in first quantization section 101 by learning, first, a large number of, for example, V LSP vectors are prepared from a large amount of learning speech data. Next, M first code vectors CODE_P^{(m)}(i) (m=0, 1, . . . , M-1, i=0, 1, . . . , R-1) are calculated using these V LSP vectors according to learning algorithms such as the LBG (Linde Buzo Gray) algorithm, to generate the first codebook.

To prepare the additive factor codebook included in additive factor selecting section 103 by learning, first, a large number of, for example, V′ LSP vectors are prepared from a large amount of learning speech data. Next, for one arbitrary LSP vector amongst prepared V′ LSP vectors, for example, for LSP^{(V′S)}(i) (where v′ₛ is an integer of 0≦v′ₛ≦V′−1), the index mₛ of the first code vector CODE_P^{(ms)}(i) (where mₛ is an integer of 0≦mₛ≦M-1) minimizing the square error between LSP^{(v′s)}(i) and the first code vector CODE_P^{(ms)}(i), is selected as the first code m_min from the first codebook, according to above equation 1. By repeating the same processing, the first codes m_min associated with all LSP vectors LSP^{(v′)}(i) (where v′ₛ is an integer of 0≦v′ₛ≦V′−1) are calculated and stored. Next, more than one LSP vector LSP^{(v′s)}(i) are extracted where the index mₛ of one arbitrary first code vector of first code vectors in the first codebook, for example, CODE_P^{(ms)}(i) (where mₛ is an integer of 0≦mₛ≦M-1), is used as the first code. Next, in each of more than one extracted LSP vector LSP^{(v′s)}(i), the residual vector ERR(i) (i=0, 1, . . . , R-1) is calculated which is the residual between the LSP vector LSP^{(v′s)}(i) and the first code vector CODE_P^{(ms)}(i), according to above equation 2. Next, the center (centroid) vector of more than one calculated residual vector ERR(i) (1=0, 1, . . . , R-1) is found and used as the additive factor code vector ADD_F^{(ms)}(i) (i=0, 1, . . . , R-1) associated with the index mₛ. By repeating the same processing, additive factor code vectors ADD_F^{(m)}(i) (m=0, 1, . . . , M-1, i=0, 1, . . . , R-1) associated with the indexes m of all first code vectors CODE_P^{(m)}(i) are calculated to generate the additive factor codebook.

In other words, more than one LSP vector are extracted in association with the same first code acquired by performing first vector quantization using the first codebook comprised of M first code vectors and V′ LSP vectors. Next, a plurality of residual vectors are calculated by subtracting the first code vector associated with the first code from each of the extracted LSP vectors, the center (centroid) of the plurality of calculated residual vectors are found, and this centroid vector is used as an additive factor code vector. Thus, all additive factor code vectors associated with the index m (m=0, 1, . . . , M-1) of each first code vector in the first codebook are found to generate the additive factor codebook.

Thus, by calculating the first codebook and the additive factor codebook, the second codebook used in second quantization section 105 can be calculated by learning, using the calculated first codebook and additive factor codebook. To be more specific, first, the first codebook and the additive factor codebook are created as described above, and a large number of, for example, V LSP vectors are calculated from a large amount of learning speech data. Next, first vector quantization is performed for V calculated LSP vectors. For example, for the vₛ-th (0≦vₛ≦V-1) LSP vector LSP^{(vs)}(i) (i=0, 1, . . . , R-1), the first code m_min is calculated according to equation 1. Next, according to equation 2, the residual vector ERR(i) (i=0, 1, . . . , R-1) is acquired which is the residual between the LSP vector LSP^{(vs)}(i) (i=0, 1, . . . , R-1) and the first code vector CODE_P^{(m}^{_{—}}^{min)}(i) (i=0, 1, . . . , R-1). Next, according to equation 3, the additive residual vector A_ERR(i) (i=0, 1, . . . , R-1) is acquired which is the residual between the residual vector ERR(i) (i=0, 1, . . . , R-1) and the additive factor code vector ADD_F^{(m}^{_{—}}^{min)}(i) (i=0, 1, . . . , R-1). Processing of calculating the additive residual vector A_ERR(i) (i=0, 1, . . . , R-1) is repeated to calculate all additive residual vectors A_ERR^{(v)}(i) (v=0, 1, . . . , V−1, i=0, 1, . . . , R-1) associated with V LSP vectors individually. Next, N second code vectors are calculated using the V calculated additive factor vectors according to learning algorithms such as the LBG algorithm, to generate the second codebook.

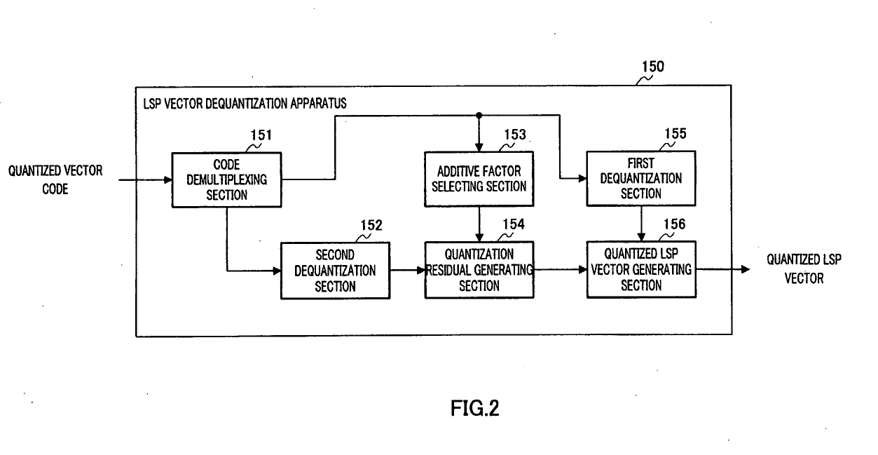

FIG. 2 is a block diagram showing main components of LSP vector dequantization apparatus 150 according to the present embodiment.

LSP vector dequantization apparatus 150 is provided with code demultiplexing section 151, second dequantization section 152, additive factor selecting section 153, quantization residual generating section 154, first dequantization section 155 and quantized LSP vector generating section 156. Further, second dequantization section 152 has the same second codebook as in second quantization section 105. Further, additive factor selecting section 153 has the same additive factor codebook as in additive factor selecting section 103. Further, first dequantization section 155 has the same first codebook as in first quantization section 101.

Code demultiplexing section 151 performs demultiplexing processing for the quantization vector code transmitted from LSP vector quantization apparatus 100 into the first code and the second code. Code demultiplexing section 151 outputs the first code to additive factor selecting section 153 and first dequantization section 155, outputs the second code to second dequantization section 152.

Second dequantization section 152 dequantizes the second code received as input from code demultiplexing section 151 using the built-in second codebook, and outputs the resulting second code vector to quantization residual generating section 154 as a quantization additive residual vector.

Additive factor selecting section 153 selects one additive factor code vector from the built-in additive factor codebook based on the first code received as input from code demultiplexing section 151, and outputs the selected additive factor code vector to quantization residual generating section 154 as an additive factor vector.

Quantization residual generating section 154 outputs to quantized LSP vector generating section 156 a quantization residual vector acquired by adding the quantization additive residual vector received as input from second dequantization section 152 and the additive factor vector received as input from additive factor selecting section 153.

First dequantization section 155 dequantizes the first code received as input from code demultiplexing section 151 using the built-in first codebook and outputs the resulting first quantization vector to quantized LSP vector generating section 156.

Quantized LSP vector generating section 156 outputs a quantized LSP vector acquired by adding the first quantization vector received as input from first dequantization section 155 and the quantization residual vector received as input from quantization residual generating section 154.

The operations of LSP vector dequantization apparatus 150 will be explained below.

Code demultiplexing section 151 performs demultiplexing processing for the inputted quantized vector code into the first code m_min and the second code n_min, and outputs the first code m_min to additive factor selecting section 153 and first dequantization section 155, and outputs the second code n_min to second dequantization section 152.

Second dequantization section 152 selects the second code vector CODE_F⁽ⁿ^{_{—}}^{min)}(i) (i=0, 1, . . . , R-1) associated with the second code n_min received as input from code demultiplexing section 151, from the built-in second codebook, and, as shown in following equation 5, outputs the selected second code vector to quantization residual generating section 154 as the quantization additive residual vector Q_A_ERR(i) (i=0, 1, . . . , R-1).

Q_{—}A_ERR(i)−CODE_{—}F⁽ⁿ^{_{—}}^{min)}(i) (i=0, . . . , R-1) (Equation 5)

Additive factor selecting section 153 selects the additive factor code vector ADD_F^{(m}^{_{—}}^{min)}(i) (i=0, 1, . . . , R-1) associated with the first code m_min received as input from code demultiplexing section 151, from the built-in additive factor codebook, and outputs the selected additive factor code vector to quantization residual generating section 154 as an additive factor vector.

Quantization residual generating section 154 adds the quantization additive residual vector Q_A_ERR(i) (i=0, 1, . . . , R-1) received as input from second dequantization section 152 and the additive factor vector ADD_F^{(m}^{_{—}}^{min)}(i) (i=0, 1, . . . , R-1) received as input from additive factor selecting section 153, according to following equation 6, and outputs the resulting vector to quantized LSP vector generating section 156 as the quantization residual vector Q_ERR(i) (i=0, 1, . . . , R-1).

Q_ERR(i)=Q_{—}A_ERR(i)+ADD_{—}F^{(m}^{_{—}}^{min)}(i) (i=0, . . . , R-1) (Equation 6)

First dequantization section 155 selects the first code vector CODE_P^{(m}^{_{—}}^{min)}(i) (i=0, 1, . . . , R-1) associated with the first code m_min received as input from code demultiplexing section 151, from the built-in first codebook, and outputs the selected first code vector to quantized LSP vector generating section 156 as a first quantization vector.

Quantized LSP vector generating section 156 adds the quantization residual vector Q_ERR(i) (i=0, 1, . . . , R-1) received as input from quantization residual generating section 154 and the first quantization vector CODE_P^{(m}^{_{—}}^{min)}(i) (i=0, 1, . . . , R-1) received as input from first dequantization section 155, according to following equation 7, and outputs the resulting vector as the quantized LSP vector Q_LSP(i) (i=0, 1, . . . , R-1).

Q_LSP(i)=Q_ERR(i)+CODE_{—}P^{(m}^{_{—}}^{min)}(i) (i=0, . . . , R-1) (Equation 7)

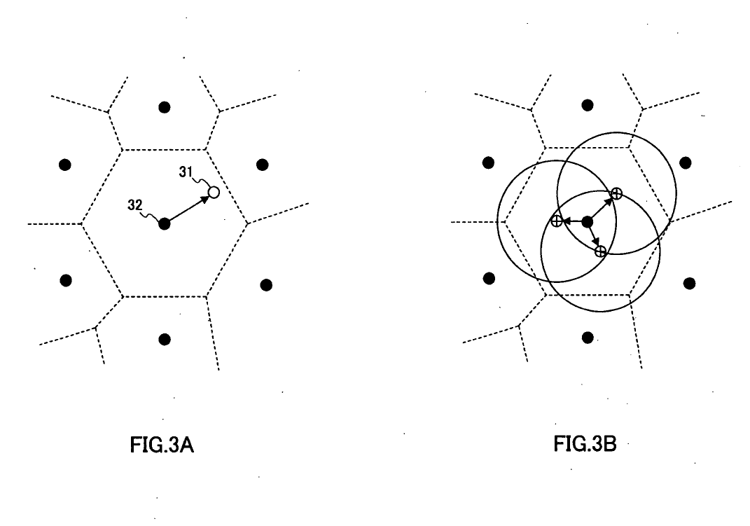

FIG. 3 illustrates a state where the vector space of second code vectors is adjusted adaptively using an additive factor vector associated with the quantization result in first quantization section 101 in LSP vector quantization apparatus 100. In this figure, for ease of explanation, an example case will be shown where the order of a first code vector and a second code vector is two, and where the vector spaces of both code vectors are present on a plane.

FIG. 3A illustrates a state where an LSP vector is quantized in first quantization section 101. Further, FIG. 3A illustrates a state where the first code vectors forming the first codebook are distributed in the vector space. In FIG. 3A, the black circles show first code vectors forming the first codebook. As shown by dotted lines in FIG. 3A, the overall vector space is divided into a plurality of regions having a first code vector in the center of the regions, and all vectors included in each region are represented by the first code vector positioned in the center of each region. That is, if vectors included in each region are quantized according to equation 1, the first code vector minimizing the square error shown in equation 1 is in the center of each region. For example, in first quantization section 101, upon quantizing the LSP vector represented by white circle 31, the first code vector selected as a first quantization vector is the first code vector represented by black circle 32. Further, in this figure, the arrow from black circle 32 to white circle 31 represents a residual vector between the first quantization vector and the LSP vector, that is, the arrow represents a quantization residual vector generated in quantization residual generating section 102. LSP vector quantization apparatus 100 quantizes this quantization residual vector using additive factor selecting section 103, additive residual generating section 104 and second quantization section 105. To be more specific, an additive factor vector is selected as a prediction for the quantization residual vector in additive factor selecting section 103, and, furthermore, the residual between the additive factor vector and the quantization residual vector is calculated as an additive residual vector in additive residual generating section 104.

FIG. 3B illustrates a state where a second code vector that is used to quantize an additive residual vector is adjusted adaptively by an additive factor vector. Further, this figure shows the vector space in which the first code vectors forming the first codebook are distributed, and shows the vector spaces which overlap the above-noted vector space and in which the second code vectors forming the second codebook are distributed. Here, the solid line circles represent vector spaces in which second code vectors are distributed, that is, the solid line circles represent second code vector spaces, these solid line circles represent vector spaces acquired by moving the center of the same second code vector space, and the circles with a cross mark represent the center of each vector space acquired by the move. LSP vector quantization apparatus 100 generates an additive residual vector by subtracting the additive factor vector from the first quantization vector. That is, the second code vector is adjusted by the additive factor vector, thereby improving the accuracy of vector quantization. This adjustment result is shown by the move of the second code vector space represented by solid line circles in FIG. 3B. Next, second quantization section 105 selects the second code vector minimizing the square error between the second code vector and the additive residual vector in the moved second codebook region, using equation 4.

As described above, according to the present embodiment, an LSP vector quantization apparatus that quantizes first quantization and second quantization in two stages adjusts the vector space of second code vectors for the second quantization adaptively, using an additive factor associated with the quantization result of the first quantization, so that it is possible to improve the accuracy of LSP vector quantization with a smaller amount of calculations and lower bit rate.

Further, although an example case has been explained with the present embodiment where the first code vectors forming a first codebook and the additive factor code vectors forming an additive factor codebook are associated in one-to-one association, the present invention is not limited to this, and the first code vectors in the first codebook and the additive factor code vectors in the additive factor codebook can be associated in N-to-one association (N is an integer equal to or greater than 2).

Further, although an example case has been explained with the present embodiment where the first code vectors forming a first codebook and the additive factor code vectors forming an additive factor codebook are associated in one-to-one association, the present invention is not limited to this, and the first code vectors forming the first codebook and the additive factor code vectors forming the additive factor codebook can be associated in one-to-N association (N is an integer equal to or greater than 2). In this case, in more than two additive factor code vectors associated with the first code, it may be preferable to select the additive factor code vector minimizing the square error Err_F⁽ⁿ⁾ (n=0, 1, . . . , N-1) calculated by equation 4. In this case, the LSP vector quantization apparatus needs to report information as to which additive factor vector is selected, to the LSP vector dequantization apparatus. For example, when the number of additive factor code vectors associated with the first code is 2^{x}, it may be preferable to report information as to which additive factor code vector is selected from 2^{x} additive factor code vectors, to the LSP dequantization apparatus by sending X-bits information.

Further, although an example case has been explained with the present embodiment where vector quantization is performed for an LSP vector in two stages, the present invention is not limited to this, and it is equally possible to perform vector quantization in three stages or more.

Further, although an example case has been explained with the present embodiment where vector quantization is performed for an LSP vector in two stages, the present invention is not limited to this, and it is equally possible to perform vector quantization while using split vector quantization. For example, when vector quantization is performed for an additive residual vector in the second stage, it is possible to split the additive residual vector into a plurality of vectors and perform vector quantization for the plurality of split vectors. In this case, it may be preferable to prepare different codebooks according to the order of the split vectors.

Further, although an example case has been explained with the present embodiment where an LSP vector is used as the quantization target, the quantization target is not limited to this, and vectors other than an LSP vector are equally possible.

Further, although a case has been described with the present embodiment where LSP vector dequantization apparatus 150 decodes a quantized vector code transmitted from LSP vector quantization apparatus 100, the present invention is not limited to this, and it is needless to say that, when encoded data in a form that can be decoded by LSP vector dequantization apparatus 150 is transmitted as a quantized vector code, vector dequantization apparatus 150 can receive and decode encoded data even if the encoded data is not transmitted from LSP vector quantization apparatus 100.

### Embodiment 2

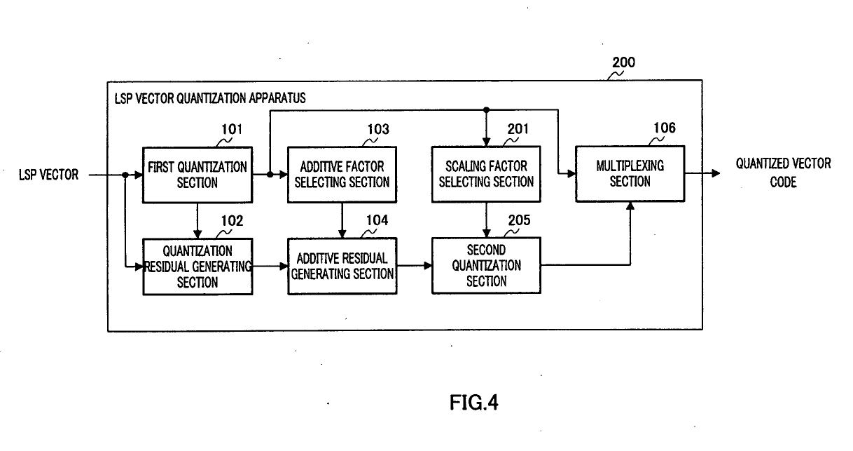

FIG. 4 is a block diagram showing main components of LSP vector quantization apparatus 200 according to the present invention. LSP vector quantization apparatus 200 has the same basic configuration as LSP vector quantization apparatus 100 (see FIG. 1) shown in Embodiment 1, and therefore the same components will be assigned the same reference numerals and explanation will be omitted. LSP vector quantization apparatus 200 is different from LSP vector quantization apparatus 100 in further having scaling factor selecting section 201. Further, second quantization section 205 of LSP vector quantization apparatus 200 and second quantization section 105 of LSP vector quantization apparatus 100 are different in part of processing, and therefore different reference numerals are assigned to show the difference. Further, second quantization 205 has the same second codebook as in second quantization section 105.

Scaling factor selecting section 201 incorporates a scaling factor table comprised of a plurality of scaling factors and selects one scaling factor associated with a first code received as input from first quantization section 101, from the built-in scaling factor table. Scaling factor selecting section 201 outputs the selected scaling factor to second quantization section 205.

Second quantization section 205 multiplies second code vectors by the scaling factor received as input from scaling factor selecting section 201, quantizes an additive residual vector received as input from additive residual generating section 104 using the second codebook multiplied by the scaling factor, and outputs the resulting second code to multiplexing section 106.

To be more specific, scaling factor selecting section 201 and second quantization section 205 having the above-noted configuration will perform the following operations.

Scaling factor selecting section 201 selects the scaling factor AMP^{(m}^{_{—}}^{min)} associated with the first code m_min received as input from first quantization section 101, from additive factors AMP^{(m)} (m=0, 1, . . . , M-1) forming the built-in additive factor table. Here, the scaling factor table has M scaling factors, and the scaling factors forming the scaling factor table are associated with the first code vectors forming the first codebook in one-to-one association. Scaling factor selecting section 201 outputs the selected scaling factor AMP^{(m}^{_{—}}^{min)} to second quantization 205.

Second quantization section 205 calculates the square error Err_F⁽ⁿ⁾ (n=0, 1, . . . , N-1) between vectors acquired by multiplying second code vectors CODE_F⁽ⁿ⁾(i) (i=0, 1, . . . , R-1, n=0, 1, . . . , N-1) forming the built-in second codebook by the scaling factor AMP^{(m}^{_{—}}^{min)} received as input from scaling factor selecting section 201 and the additive residual vector A_ERR⁽ⁱ⁾ (i=0, 1, . . . , R-1) received as input from additive residual generating section 104, according to following equation 8.

$${Err\_F}^{( n )} = {\sum }_{i = 0}^{R - 1} {( \begin{matrix}A\_ERR ( i ) - {AMP}^{( m\_min )} \times \\ {CODE\_F}^{( n )} ( i )\end{matrix} )}^{2} \qquad ( Equation 8 )$$

Here, n is the index of each second code vector forming the second codebook, and N is the total number of the second code vectors forming the second codebook. In N square errors Err_F⁽ⁿ⁾ (n=0, 1, . . . , N-1) calculated, second quantization section 205 outputs the value n_min of n where the square error Err_F⁽ⁿ⁾ is minimum, as the second code, to multiplexing section 106.

The scaling factor table used in scaling factor selecting section 201 is prepared and created in advance by learning, and the method of learning the scaling factor table will be explained.

To prepare the scaling factor table included in scaling factor selecting section 201 by learning, as shown in Embodiment 1, after the first codebook, additive factor codebook and second codebook are prepared by learning, a large number of, for example, V̂ LSP vectors acquired from a large amount of speech data for learning are prepared. Next, the first codes associated with the prepared V̂ LSP vectors are prepared. For example, for LSP^{(v̂s)}(i) (where v̂ₛ is an integer of 0≦v̂ₛ≦v̂ₛ−1), the index mₛ of the first code vector CODE_P^{(ms)}(i) (where mₛ is an integer of 0≦mₛ≦M-1) minimizing the square error between LSP^{(v̂s)}(i) and the first code vector is selected as the first code m_min from the first codebook, according to above equation 1. By repeating the same processing, the first codes m_min associated with all LSP vectors LSP^{(v̂s)}(i) (where v̂ₛ is an integer of 0≦v̂ₛ≦v̂ₛ−1) are calculated and stored. Next, more than one LSP vector LSP^{(v̂s)}(i) are extracted where the index mₛ of an arbitrary first code vector forming the first codebook, for example, CODE_P^{(ms)}(i) (where mₛ is an integer of 0≦mₛ≦M-1), is used as the first code m_min. Next, in each of more than one extracted LSP vector LSP^{(v̂s)}(i), the residual vector ERR(i) (i=0, 1, . . . , R-1) which is the residual between the LSP vector LSP^{(v̂s)}(i) and the first code vector CODE_P^{(ms)}(i), is calculated according to above equation 2. Next, the additive residual vector A_ERR(i) (i=0, 1, . . . , R-1) which is the residual between the residual vector ERR(i) (i=0, 1, . . . , R-1) and the additive factor ADD_F^{(m}^{_{—}}^{min)}(i) (i=0, 1, . . . , R-1), is calculated according to above equation 3. Next, the square error Err_F⁽ⁿ⁾ (n=0, 1, . . . , N-1) between the additive residual vector A_ERR(i) (i=0, 1, . . . , R-1) and the second code vector CODE_F⁽ⁿ⁾(i) (i=0, 1, . . . , R-1, n=0, 1, . . . , N-1), is calculated according to above equation 4, and, in the N calculated square errors Err_F⁽ⁿ⁾, the value n_min where the square error Err_F⁽ⁿ⁾ is minimum is used as the second code.

By repeating the same processing for more than one LSP vector LSP^{(v̂s)}(i) where the index mₛ is used as the first code m_min, the second code n_min associated with each of LSP vectors LSP^{(v̂s)}(i) are calculated and stored. Next, AMP^{(m}^{_{—}}^{min)} where the total of square errors Err_Total calculated by following equation 9 is minimum, is used as a scaling factor associated with the first code m_min.

$$Err\_Total = {\sum }_{w = 0}^{W ( {m}_{s} )} {\sum }_{i = 0}^{R - 1} {( \begin{matrix}{A\_ERR}^{( w )} ( i ) - {AMP}^{( m\_min )} \times \\ {CODE\_F}^{( {n\_min}^{( w )} )} ( i )\end{matrix} )}^{2} \qquad ( Equation 9 )$$

Here, W^{(ms)} is the total number of LSP vectors LSP(v̂ₛ)(i) where the index mₛ is used as the first code m_min. A_ERR^{(w)}(i) (i=0, 1, . . . , R-1, w=0, 1, . . . , W^{(ms)}−1) is the additive residual vector acquired from the LSP vector LSP(v̂ₛ)(i) where the index mₛ is used as the code m_min. CODE_F⁽ⁿ^{_{—}}^{min(w))}(i) is the second code vector where the square error is determined to be minimum between the second code and A_ERR^{(w)}(i) according to above equation 4.

Thus, the scaling factor AMP^{(m}^{_{—}}^{min)} associated with the index m (m=0, 1, . . . , M-1) of each first code vector of the first codebook is calculated to generate the scaling factor table.

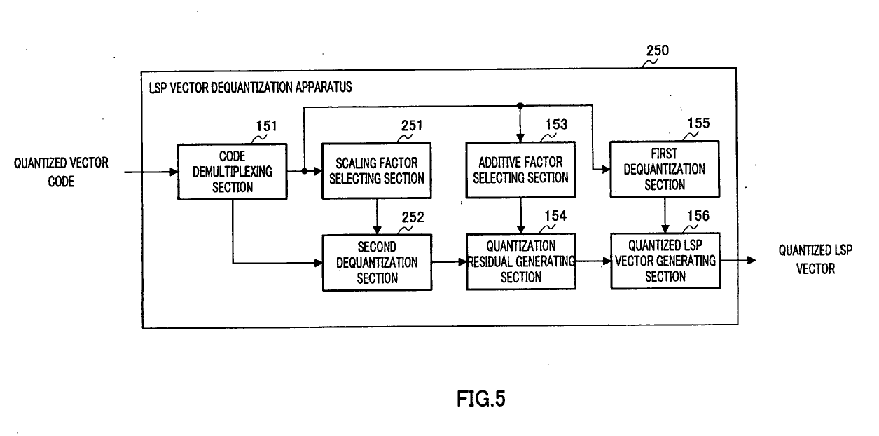

FIG. 5 is a block diagram showing main components of LSP vector dequantization apparatus 250 according to the present embodiment. LSP vector dequantization apparatus 250 has the same basic configuration as in LSP vector dequantization apparatus 150 (see FIG. 2) shown in Embodiment 1, and therefore the same components will be assigned the same reference numerals and explanation will be omitted. LSP vector dequantization apparatus 250 is different from LSP vector dequantization apparatus 150 in further having scaling factor selecting section 251. Further, second dequantization section 252 of LSP vector dequantization apparatus 250 and second dequantization section 152 of LSP vector dequantization apparatus 150 are different in part of processing, and therefore different reference numerals are assigned to show the difference.

Scaling factor selecting section 251 incorporates the same scaling factor table as in scaling factor selecting section 201 of LSP vector quantization 200, and selects a scaling factor associated with the first code received as input from code demultiplexing section 151, from the built-in scaling factor table, and outputs the selected scaling factor to second dequantization section 252.

Second dequantization section 252 dequantizes the second code received as input from code demultiplexing section 151 using the built-in second codebook, multiplies the resulting second code vector by the scaling factor received as input from scaling factor selecting section 251 and outputs the second code vector multiplied by the scaling factor to quantization residual generating section 154.

To be more specific, scaling factor selecting section 251 and second dequantization section 252 having the above-noted configuration will perform the following operations.

Scaling factor selecting section 251 selects the scaling factor AMP^{(m}^{_{—}}^{min)} associated with the first code m_min received as input from code demultiplexing section 151, from the built-in scaling factor table, and outputs the selected scaling factor to second dequantization section 252.

Second dequantization section 252 selects the second code vector CODE_F⁽ⁿ^{_{—}}^{min)}(i) (i=0, 1, . . . , R-1) associated with the second code n min received as input from code demultiplexing section 151, from the built-in second codebook, multiplies the second code vector CODE_F⁽ⁿ^{_{—}}^{min)}(i) (i=0, 1, . . . , R-1) by the scaling factor AMP^{(m}^{_{—}}^{min)} received as input from scaling factor selecting section 251, according to following equation 10, and outputs the resulting vector to quantization residual generating section 154 as the quantization additive residual vector Q_A_ERR(i) (i=0, 1, . . . , R-1).

Q_{—}A_ERR(i)=AMP^{(m}^{_{—}}^{min)}×CODE_{—}F⁽ⁿ^{_{—}}^{min)}(i) (i=0, . . . , R-1) (Equation 10)

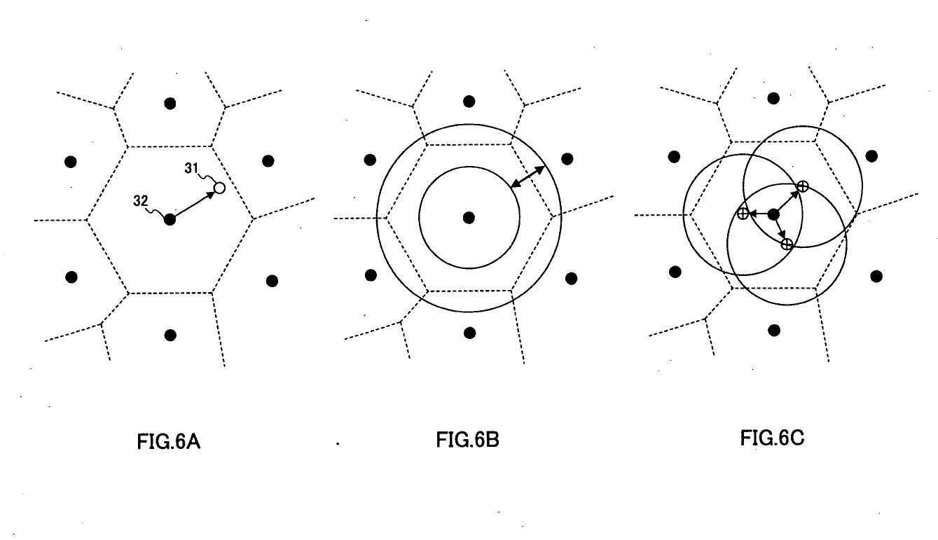

FIG. 6 illustrates a state where the vector space of second code vectors is adaptively adjusted using a scaling factor in addition to an additive factor vector associated with a quantization result in first quantization section 101 of LSP vector quantization apparatus 200.

FIG. 6 is similar to FIG. 3A and therefore detailed explanation will be omitted.

FIG. 6B illustrates a state where second code vectors are adjusted adaptively by a scaling factor. This figure shows the vector space in which first code vectors forming the first codebook are distributed, and also shows the vector spaces which overlap the above-noted vector space and in which second code vectors forming the second codebook are distributed. Here, the solid line circles show vector spaces in which second code vectors are distributed, that is, the solid line circles show the second code vector spaces, and two solid line circles of the inner circle and outer circle show the scaling of the second code vector space. This scaling is performed by multiplying the second code vectors forming the second codebook by a scaling factor in second quantization section 205. Scaling factors to scale the second code vector space are associated with first quantization vectors in one-to-one association, and, by this scaling processing, the vector space of second code vectors are adjusted further adaptively, thereby improving quantization accuracy.

FIG. 6C is basically similar to FIG. 3B, and detailed explanation will be omitted. However, FIG. 6C is different from FIG. 3B in that, as shown in FIG. B, the second code vector spaces represented by solid line circles are acquired by performing scaling processing using scaling factors.

As described above, according to the present embodiment, the LSP vector quantization apparatus that performs first quantization and second quantization adjusts the vector space of second code vectors for second quantization further adaptively, using a scaling factor associated with the quantization result in the first quantization, so that it is possible to further improve the accuracy of LSP vector quantization with a lower amount of calculations and lower bit rate.

### Embodiment 3

With the present embodiment, multistage vector quantization in two stages is performed for an LSP vector, and, furthermore, in the vector quantization in the second stage, the LSP vector is split into two and quantized using the vector quantization result in the first stage.

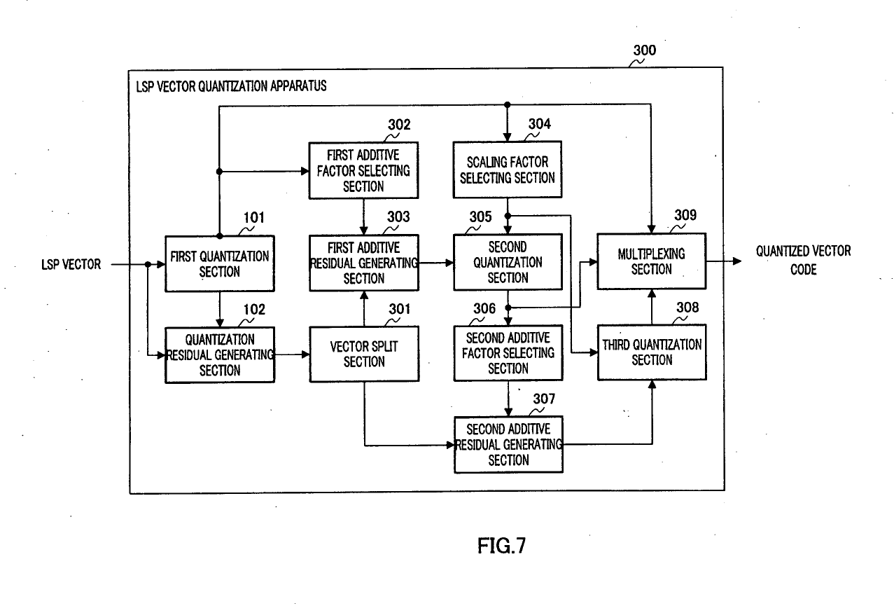

FIG. 7 is a block diagram showing main components of LSP vector quantization apparatus 300 according to Embodiment 3.

In FIG. 7, LSP vector quantization apparatus 300 is provided with first quantization section 101, quantization residual generating section 102, vector split section 301, first additive factor selecting section 302, first additive residual generating section 303, scaling factor selecting section 304, second quantization section 305, second additive factor selecting section 306, second additive residual generating section 307, third quantization section 308 and multiplexing section 309. Here, first quantization section 101 and quantization residual generating section 102 are the same as first quantization section 101 and quantization residual generating section 102 in Embodiment 2, and therefore explanation will be omitted.

Vector split section 301 splits a quantization residual vector received as input from quantization residual generating section 102 into two to generate two split vectors. Vector split section 301 outputs a split vector with a lower order associated with a lower frequency domain, as a first split vector, to first additive residual generating section 303, and outputs a split vector with a higher order associated with a higher frequency domain, as a second split vector, to second additive residual generating section 307.

First additive factor selecting section 302 incorporates a first additive factor codebook comprised of a plurality of first additive factor code vectors, and selects one additive factor code vector from the first additive factor codebook based on the first code received as input from first quantization section 101. First additive factor selecting section 302 outputs the selected first additive factor code vector to first additive residual generating section 303 as a first additive factor vector.

First additive residual generating section 303 calculates the residual between the first split vector received as input from vector split section 301 and the first additive factor vector received as input from first additive factor selecting section 302, and outputs the calculated residual to second quantization section 305 as a first additive residual vector.

Scaling factor selecting section 304 incorporates a scaling factor table comprised of a plurality of scaling factors, and selects one scaling factor from the scaling factor table based on the first code received as input from first quantization section 101. Scaling factor selecting section 304 outputs the selected scaling factor to second quantization section 305 and third quantization section 308.

Second quantization section 305 incorporates a first split codebook comprised of a plurality of first split code vectors, and multiplies each first code vector by the scaling factor received as input from scaling factor selecting section 304. Further, second quantization section 305 quantizes the first additive residual vector received as input from first additive residual generating section 303, using the first split codebook multiplied by the scaling factor, and outputs the resulting second code to second additive factor selecting section 306 and multiplexing section 309.

Second additive factor selecting section 306 incorporates a second additive factor codebook comprised of a plurality of second additive factor code vectors, and selects one second additive factor code vector from the second additive factor codebook based on the second code received as input from second quantization section 305. Second additive factor selecting section 306 outputs the selected second additive factor code vector to second additive residual generating section 307 as a second additive factor vector.

Second additive residual generating section 307 calculates the residual between the second split vector received as input from vector split section 301 and the second additive factor vector received as input from second additive factor selecting section 306, and outputs the residual to third quantization section 308 as a second additive residual vector.

Third quantization section 308 incorporates a second split codebook comprised of a plurality of second split code vectors, and multiplies each second split code vector by the scaling factor received as input from scaling factor selecting section 304. Further, third quantization section 308 quantizes the second additive residual vector received as input from second additive residual generating section 307, using the second split codebook multiplied by the scaling factor, and outputs the resulting third code to multiplexing section 309.

Multiplexing section 309 multiplexes the first code received as input from first quantization section 101, the second code received as input from second quantization section 305 and the third code received as input from third quantization section 308, and outputs the resulting code as a quantized vector code.

To be more specific, vector split section 301, first additive factor selecting section 302, first additive residual generating section 303, scaling factor selecting section 304, second quantization section 305, second additive factor selecting section 306, second additive residual generating section 307, third quantization section 308 and multiplexing section 309 having the above-noted configuration performs the following operations.

Vector split section 301 splits the quantization residual vector ERR(i) (i=0, 1, . . . , R-1) received as input from quantization residual generating section 102 into the first split vector of order R_P and the second split vector of order R_F, according to following equation 11.

ERR_{—}P(i)=ERR(i) (i=0, . . . , R_{—}P-1)

ERR_{—}F(i)=ERR(i+R_{—}P) (i=0, . . . , R_{—}F-1) (Equation 11)

Here, the total of R_P and R_F is R, and therefore the relationship R_P+R_F=R holds. Vector split section 301 outputs ERR_P(i) (i=0, 1, . . . , R_P-1) to first additive residual generating section 303 as a first split vector and outputs ERR_F(i) (i=0, 1, . . . , R_F-1) to second additive residual generating section 307 as a second split vector.

First additive factor selecting section 302 selects the first additive factor code vector ADD_F_P^{(m}^{_{—}}^{min)}(i) (i=0, 1, . . . , R_P-1) associated with the first code m_min received as input from first quantization section 101, from first additive factor code vectors ADD_F_P^{(m)}(i) (m=0, 1, . . . , i=0, 1, . . . , R_P-1) forming the built-in first additive factor codebook. Here, the first additive factor codebook is comprised of M first additive factor code vectors, and the first additive factor code vectors forming the first additive factor codebook are associated with the first code vectors forming the first codebook in one-to-one association. First additive factor selecting section 302 outputs the selected first additive factor code vector ADD_F_P^{(m}^{_{—}}^{min)}(i) (i=0, 1, . . . , R_P-1) to first additive residual generating section 303 as a first additive factor vector.

First additive residual generating section 303 calculates the residual A_ERR_P(i) (i=0, 1, . . . , R_P-1) between the first split vector ERR_P(i) (i=0, 1, . . . , R_P-1) received as input from vector split section 301 and the first additive factor vector ADD_F_P⁽ⁿ^{_{—}}^{min)}(i) (i=0, 1, . . . , R_P-1) received as input from first additive factor selecting section 302, according to following equation 12.

A_ERR_{—}P(i)=ERR_{—}P(i)−ADD_{—}F_{—}P^{(m}^{_{—}}^{min)}(i) (i=0, . . . , R_{—}P-1) (Equation 12)

First additive residual generating section 303 outputs the calculated A_ERR_P(i) (i=0, 1, . . . , R_P-1) to second quantization section 305 as a first additive residual vector.

Scaling factor selecting section 304 selects the scaling factor AMP^{(m}^{_{—}}^{min)} associated with the first code m_min received as input from first quantization section 101, from scaling factors AMP^{(m)} (m=0, 1, . . . , M-1) forming the built-in scaling factor table. Here, the scaling factor table is comprised of M scaling factors, and the scaling factors forming the scaling factor table are associated with the first code vectors forming the first codebook in one-to-one association. Scaling factor selecting section 304 outputs the selected scaling factor AMP^{(m}^{_{—}}^{min)} to second quantization section 305 and third quantization section 308.

Second quantization section 305 multiplies first split code vectors CODE_F_P⁽ⁿ⁾(i) (i=0, 1, . . . , R_P-1, n=0, 1, . . . , N-1) forming the built-in first split codebook by the scaling factor AMP^{(m}^{_{—}}^{min)} received as input from scaling factor selecting section 304. Further, second quantization section 305 calculates the square errors Err_F_P⁽ⁿ⁾ (n=0, 1, . . . , N-1) between the resulting multiplied vectors and the first additive residual vector A_ERR_P(i) (i=0, 1, . . . , R_P-1) received as input from first additive residual generating section 303, according to following equation 13.

$$Err\_F {\_P}^{( n )} = {\sum }_{i = 0}^{R\_P - 1} {( \begin{matrix}A\_ERR \_P ( i ) - {AMP}^{( n\_min )} \times \\ CODE\_F {\_P}^{( n )} ( i )\end{matrix} )}^{2} \qquad ( Equation 13 )$$

Here, n is the index of each first split code vector forming the first split codebook, and N is the total number of first split code vectors forming the first split codebook. Second quantization section 305 outputs the value n min of n where the square error Err_F_P⁽ⁿ⁾ is minimum amongst the N square errors Err_F_P⁽ⁿ⁾ (n=0, 1, . . . , N-1) calculated, to second additive factor selecting section 306 and multiplexing section 309 as a second code.

Second additive factor selecting section 306 selects the second additive factor code vector ADD_F_F⁽ⁿ^{_{—}}^{min)}(i) (i=0, 1, . . . , R_F-1) associated with the second code n_min received as input from second quantization section 305, from second additive factor code vectors ADD_F_F⁽ⁿ⁾(i) (n=0, 1, . . . , i=0, 1, . . . , R_F-1) forming the built-in second additive factor codebook. Here, the second additive factor codebook is comprised of N second additive factor vectors, and the second additive factor vectors forming the second additive factor codebook are associated with the first code vectors forming the first codebook in one-to-one association. Second additive factor selecting section 306 outputs the selected second additive factor code vector ADD_F_F⁽ⁿ^{_{—}}ₘᵢₙ₎(i) (i=0, 1, . . . , R_F-1) to second additive residual generating section 307 as a second additive factor vector.

Second additive residual generating section 307 calculates the residual A_ERR_F(i) (i=0, 1, . . . , R_F-1) between the second split vector ERR_F(i) (i=0, 1, . . . , R_F-1) received as input from vector split section 301 and the second additive factor vector ADD_F_F⁽ⁿ^{_{—}}^{min)}(i) (i=0, 1, . . . , R_F-1) received as input from second additive factor selecting section 306, according to following equation 14.

A_ERR_{—}F(i)=ERR_{—}F(i)−ADD_{—}F_{—}F⁽ⁿ^{_{—}}^{min)}(i) (i=0, . . . , R_{—}F-1) (Equation 14)

Second additive residual generating section 307 outputs the calculated A_ERR_F(i) (i=0, 1, . . . , R_F-1) to third quantization section 308 as a second additive residual vector.

Third quantization section 308 multiplies second split code vectors CODE_F_F^{(o)}(i) (i=0, 1, . . . , R_F-1, o=0, 1, . . . , O-1) forming the built-in second split codebook by the scaling factor AMP^{(m}^{_{—}}^{min)} received as input from scaling factor selecting section 304. Further, third quantization section 308 calculates the square errors Err_F_F^{(o)} (o=0, 1, . . . , O-1) between the resulting multiplied vectors and the second additive residual vector A_ERR_F(i) (i=0, 1, . . . , R_F-1) received as input from second additive residual generating section 307, according to equation 15.

$$Err\_F {\_F}^{( o )} = {\sum }_{i = 0}^{R\_F - 1} {( \begin{matrix}A\_ERR \_F ( i ) - {AMP}^{( m\_min )} \times \\ CODE\_F {\_F}^{( o )} ( i )\end{matrix} )}^{2} \qquad ( Equation 15 )$$

Here, o is the index of each second split cod e vector forming the second split codebook, and O is the total number of the second split code vectors forming the second split codebook. In O square errors Err_F_F^{(o)} (o=0, 1, . . . , O-1) calculated, third quantization section 308 outputs the value o_min of o where the square error Err_F_F^{(o)} is minimum, to multiplexing section 309 as a second code.

Multiplexing section 309 multiplexes the first code m_min received as input from first quantization section 101, the second code n_min received as input from second quantization section 305 and the third code o_min received as input from third quantization section 308, and transmits the resulting quantized vector code to LSP vector dequantization apparatus 350.

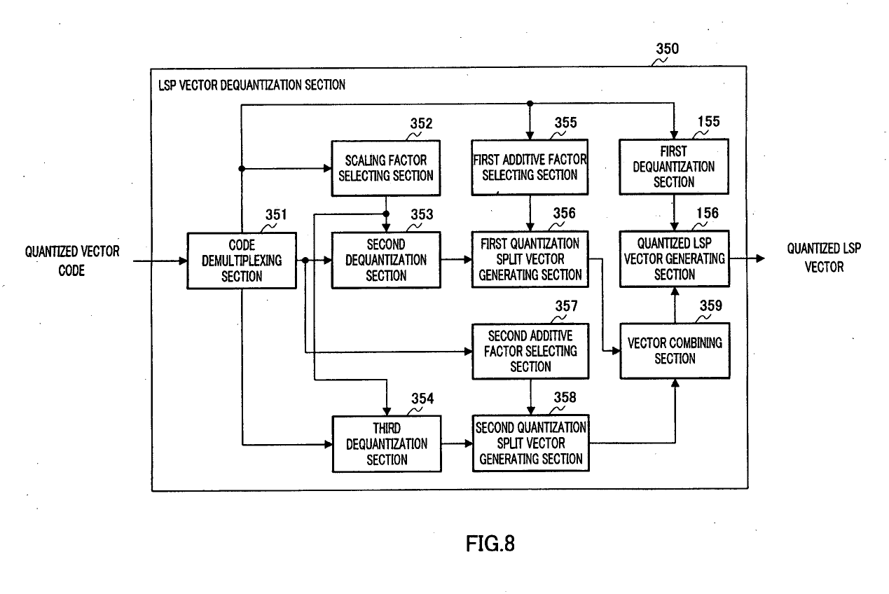

FIG. 8 is a block diagram showing main components of LSP vector dequantization apparatus 350 according to the present embodiment.

LSP vector dequantization apparatus 350 is provided with first dequantization section 155, quantized LSP vector generating section 156, code demultiplexing section 351, scaling factor selecting section 352, second dequantization section 353, third dequantization section 354, first additive factor selecting section 355, first quantization split vector generating section 356, second additive factor selecting section 357, second quantization split vector generating section 358 and vector combining section 359. Here, first dequantization section 155 and quantized LSP vector generating section 156 are the same as first dequantization section 155 and quantized LSP vector generating section 156 in Embodiment 2, and therefore explanation will be omitted. Further, scaling factor selecting section 352 has the same scaling factor table as in scaling factor selecting section 304 of LSP vector quantization apparatus 300. Further, second dequantization section 353 has the same first split codebook as in second quantization section 305 of LSP vector quantization section 300. Further, third dequantization 354 has the same second split codebook as in third quantization section 308 of LSP vector quantization section 300. Further, first additive factor selecting section 355 has the same first additive factor codebook as in first additive factor selecting section 302 of LSP vector quantization apparatus 300. Further, second additive factor selecting section 357 has the same second additive factor codebook as in second additive factor selecting section 306 of LSP vector quantization apparatus 300.

Code demultiplexing section 351 performs dequantization processing for the quantized vector code transmitted from LSP vector quantization apparatus 300 into the first code, second code and third code. Code demultiplexing section 351 outputs the first code to scaling factor selecting section 352, first additive factor selecting section 355 and first dequantization section 155, outputs the second code to second dequantization section 353 and second additive factor selecting section 357, and outputs the third code to third dequantization section 354.

Scaling factor selecting section 352 selects one scaling factor from the built-in scaling factor table based on the first code received as input from code demultiplexing section 351, and outputs the selected scaling factor to second dequantization section 353 and third dequantization section 354.

Second dequantization section 353 dequantizes the second code received as input from code demultiplexing section 351 using the built-in first split codebook to acquire a first split code vector. Second dequantization section 353 multiplies the acquired first split code vector by the scaling factor received as input from scaling factor selecting section 352 and outputs the first split code vector multiplied by the scaling factor to first quantization split vector generating section 356 as a first quantization additive residual vector.

Third dequantization section 354 dequantizes the third code received as input from code demultiplexing section 351 using the built-in second split codebook to acquire second split code vector. Third dequantization section 354 multiplies the acquired second split code vector by the scaling factor received as input from scaling factor selecting section 352 and outputs the second split code vector multiplied the scaling factor to second quantization split vector generating section 358 as a second quantization additive residual vector.

First additive factor selecting section 355 selects one first additive factor code vector from the built-in first additive factor codebook based on the first code received as input from code demultiplexing section 351, and outputs the selected first additive factor code vector to first quantization split vector generating section 356 as a first additive factor vector.

First quantization split vector generating section 356 outputs to vector combining section 359 the first quantization split vector acquired by adding the first quantization additive residual vector received as input from second dequantization section 353 and the first additive factor vector received as input from first additive factor selecting section 355.

Second additive factor selecting section 357 selects one second additive factor code vector from the built-in second additive factor codebook based on the second code received as input from code demultiplexing section 351, and outputs the selected second additive factor code vector to second quantization split vector generating section 358 as a second additive factor vector.

Second quantization split vector generating section 358 outputs to vector combining section 359 the second quantization split vector acquired by adding the second quantization additive residual vector received as input from third dequantization section 354 and the second additive factor vector received as input from second additive factor selecting section 357.

Vector combining section 359 combines the first quantization split vector received as input from first quantization split vector generating section 356 and the second quantization split vector received as input from second quantization split vector generating section 358, and outputs the resulting quantization residual vector to quantized LSP vector generating section 156.

To be more specific, code demultiplexing section 351, scaling factor selecting section 352, second dequantization section 353, third dequantization section 354, first additive factor selecting section 355, first quantization split vector generating section 356, second additive factor selecting section 357, second quantization split vector generating section 358 and vector combining section 359 employing the above-noted configurations will perform the following operations.

Code demultiplexing section 351 performs demultiplexing processing for the quantized vector code transmitted from LSP vector quantization apparatus 300 into the first code m_min, second code n min and third code o_min, outputs the first code m_min to scaling factor selecting section 352, first additive factor selecting section 355 and first dequantization section 155, outputs the second code n_min to second dequantization section 353 and second additive factor selecting section 357, and outputs the third code o_min to third dequantization section 354.

Scaling factor selecting section 352 selects the scaling factor AMP^{(m}^{_{—}}^{min)} associated with the first code m_min received as input from code demultiplexing section 351, from the built-in scaling factor table and outputs the selected scaling factor to second dequantization section 353 and third dequantization section 354.

Second dequantization section 353 selects the first split code vector CODE_F_P⁽ⁿ^{_{—}}^{min)}(i) (i=0, 1, . . . , R_P-1) associated with the second code received as input from code demultiplexing section 351, from the built-in first codebook. Further, second dequantization section 353 multiplies the scaling factor AMP^{(m}^{_{—}}^{min)} received as input from scaling factor selecting section 352 and the first split code vector CODE_F_P⁽ⁿ^{_{—}}^{min)}(i) (i=0, 1, . . . , R_P-1), according to following equation 16, and outputs the resulting vector to first quantization split vector generating section 356 as the first quantization additive residual vector Q_A_ERR_P(i) (i=0, 1, . . . , R_P-1).

Q_{—}A_ERR_{—}P(i)=AMP^{(m}^{_{—}}^{min)}×CODE_{—}F_{—}P⁽ⁿ^{_{—}}^{min)}(i) (i=0, . . . , R_{—}P-1) (Equation 16)

Third dequantization section 354 selects the second split code vector CODE_F_F^{(o}^{_{—}}^{min)}(i) (i=0, 1, . . . , R_F-1) associated with the third code o_min received as input from code demultiplexing section 351, from the built-in second split codebook. Further, third dequantization section 354 multiplies the scaling factor AMP^{(m}^{_{—}}^{min)} received as input from scaling factor selecting section 352 and the second split code vector CODE_F_F^{(o}^{_{—}}^{min)}(i) (i=0, 1, . . . , R_F-1) according to following equation 17, and outputs the resulting vector to second quantization split vector generating section 358 as the second quantization additive residual vector Q_A_ERR_F(i) (i=0, 1, . . . , R_F-1).

Q_{—}A_ERR_{—}F(i)=AMP^{(m}^{_{—}}^{min)}×CODE_{—}F_{—}F^{(o}^{_{—}}^{min)}(i) (i−0, . . . , R_{—}F-1) (Equation 17)

First additive factor selecting section 355 selects the first additive factor code vector ADD_F_P^{(m}^{_{—}}^{min)}(i) (i=0, 1, . . . , R_P-1) associated with the first code m_min received as input from code demultiplexing section 351, from the built-in first additive factor codebook and outputs the selected additive factor code vector to first quantization split vector generating section 356 as a first additive factor vector.

First quantization split vector generating section 356 adds the first quantization additive residual vector Q_A_ERR_P(i) (i=0, 1, . . . , R_P-1) received as input from second dequantization section 353 and the first additive factor vector ADD_F_P^{(m}^{_{—}}^{min)}(i) (i=0, 1, . . . , R_P-1) received as input from first additive factor selecting section 355, according to following equation 18, and outputs the resulting vector to vector combining section 359 as the first quantization split vector Q_ERR_P(i) (i=0, 1, . . . , R_P-1).

Q_ERR_{—}P(i)=Q_{—}A_ERR_{—}P(i)+ADD_{—}F^{—}P^{(m}^{_{—}}^{min)}(i) (i=0, . . . , R_{—}P-1) (Equation 18)

Second additive factor selecting section 357 selects the second additive factor code vector ADD_F_F⁽ⁿ^{_{—}}^{min)}(i) (i=0, 1, . . . , R_F-1) associated with the second code n_min received as input from code demultiplexing section 351, from the built-in second additive factor codebook, and outputs the selected second additive factor code vector to second quantization split vector generating section 358 as a second additive factor vector.

Second quantization split vector generating section 358 adds the second quantization additive residual vector Q_A_ERR_F(i) (i=0, 1, . . . , R_F-1) received as input from third dequantization section 354 and the second additive factor vector ADD_F_F⁽ⁿ^{_{—}}^{min)}(i) (i=0, 1, . . . , R_F-1) received as input from second additive factor selecting section 357, according to following equation 19, and outputs the resulting vector to vector combining section 359 as the second quantization split vector Q_ERR_F(i) (i=0, 1, . . . , R_F-1).

Q_ERR_{—}F(i)=Q_{—}A_ERR_{—}F(i)+ADD_{—}F_{—}F⁽ⁿ^{_{—}}^{min)}(i) (i=0, . . . , R_{—}F-1) (Equation 19)

Vector combining section 359 combines the first quantization split vector Q_ERR_P(i) (i=0, 1, . . . , R_P-1) received as input from first quantization split vector generating section 356 and the second quantization split vector Q_ERR_F(i) (i=0, 1, . . . , R_F-1) received as input from second quantization split vector generating section 358, according to following equation 20, and outputs the resulting quantization residual vector Q_ERR(i) (i=0, 1, . . . , R-1) to quantized LSP vector generating section 156.

Q_ERR(i)=Q_ERR_{—}P(i) (i=0, . . . , R_{—}P-1)

Q_ERR(i+R_{—}P)=Q_ERR_{—}F(i) (i=0, . . . , R_{—}F-1) (Equation 20)

As described above, according to the present embodiment, the LSP vector quantization apparatus, which performs quantization in two stages of the first quantization and second quantization, splits into two and quantizes a vector in the second quantization, and, in this split vector quantization, adaptively adjusts the vector space of code vectors for quantization of one split vector based on the quantization result of the other split vector. Therefore, it is possible to further improve the accuracy of LSP vector quantization with a smaller amount of calculations and lower bit rate.

Further, although a case has been described with the present embodiment where LSP vector quantization apparatus splits into two and quantizes a vector in the second quantization, the present invention is not limited to this, and it is equally possible to split into three or more and quantize a vector in the second quantization. In this case, the quantization accuracy increases when correlation is higher between split vectors acquired by splitting the quantization target.

### Embodiment 4

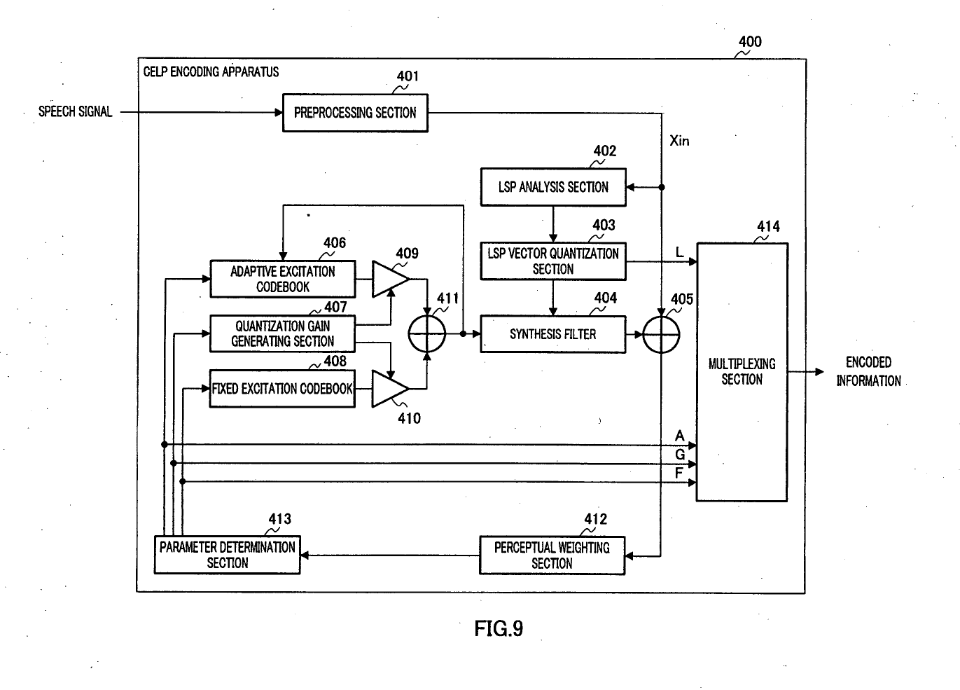

FIG. 9 is a block diagram showing main components of CELP encoding apparatus 400 according to the present embodiment.

CELP encoding apparatus 400 is provided with preprocessing section 401, LSP analysis section 402, LSP vector quantization section 403, synthesis filter 404, adder 405, adaptive excitation codebook 406, quantization gain generating section 407, fixed excitation codebook 408, multipliers 409 and 410, adder 411, perceptual weighting section 412, parameter determination section 413 and multiplexing section 414, where LSP vector quantization section 403 is formed with LSP vector quantization apparatus 100 according to Embodiment 1, LSP vector quantization apparatus 200 according to Embodiment 2 or LSP vector quantization apparatus 300 according to Embodiment 3. Further, CELP encoding apparatus 400 divides input speech or audio signal in units of a plurality of samples, and performs encoding every frame comprised of the plurality of samples.

Preprocessing section 401 processes an input speech or audio signal by performing highpass filtering processing to remove the DC components, waveform shaping processing or preemphasis processing for improved performance in subsequent encoding processing, and outputs the signal Xin resulted from these processing, to LSP analysis section 402 and adder 405.

LSP analysis section 402 performs a linear predictive analysis using Xin received as input from preprocessing section 401, converts the resulting LPC into an LSP vector and outputs the LSP vector to LSP vector quantization section 403.

LSP vector quantization section 403 quantizes the LSP vector received as input from LSP analysis section 402. Further, LSP vector quantization section 403 outputs the resulting quantized LSP vector to synthesis filter 404 and outputs the quantized LSP code (L) to multiplexing section 414.

Synthesis filter 404 outputs to adder 405 a synthesis signal generated by performing synthesis processing with respect to excitation received as input from adder 411, which will be described later, using filter coefficients based on the quantized LSP vector received as input from LSP vector quantization section 403.

Adder 405 calculates an error signal by inverting the polarity of the synthesis signal received as input from synthesis filter 404 and adding the result to the signal Xin received as input from preprocessing section 401, and outputs the error signal to perceptual weighting section 412.

Adaptive excitation codebook 406 that stores excitations received as input from adder 411 in the past in a buffer, and cuts out one frame of samples in the buffer from the cut position specified by the adaptive excitation lag code (A) received as input from parameter determination section 413, and outputs the one frame of samples to multiplier 409 as an adaptive excitation vector. Here, adaptive excitation codebook 406 updates content of the buffer every time an excitation is received as input from adder 411.

Quantization gain generating section 407 determines a quantized adaptive excitation gain and quantized fixed excitation gain by the quantized excitation gain code (G) received as input from parameter determination section 413, and outputs the quantized adaptive excitation gain and quantized fixed excitation gain to multiplier 409 and multiplier 410, respectively.

Fixed excitation codebook 408 outputs a vector having the form specified by the fixed excitation vector code (F) received as input from parameter determination section 413, to multiplier 410 as a fixed excitation vector.

Multiplier 409 multiplies the adaptive excitation vector received as input from adaptive excitation codebook 406 by the quantized adaptive excitation gain received as input from quantization gain generating section 407, and outputs the result to adder 411.

Multiplier 410 multiplies the fixed excitation vector received as input from fixed excitation codebook 408 by the quantized fixed excitation gain received as input from quantization gain generating section 407, and outputs the result to adder 411.

Adder 411 adds the adaptive excitation vector after gain multiplication received as input from multiplier 409 and the fixed excitation vector after gain multiplication received as input from multiplier 410, and outputs the addition result to synthesis filter 404 and adaptive excitation codebook 406 as an excitation. Here, the excitation inputted in adaptive excitation codebook 406 is stored in the buffer of adaptive excitation codebook 406.

Perceptual weighting section 412 performs perceptual weighting processing for the error signal received as input from adder 405, and outputs the result to parameter determination section 413 as coding distortion.

Parameter determination section 413 selects the adaptive excitation lag that minimizes the coding distortion received as input from perceptual weighting section 412, from adaptive excitation codebook 406, and outputs the adaptive excitation lag code (A) indicating the selection result to adaptive excitation codebook 406 and multiplexing section 414. Here, an adaptive excitation lag is the parameter for indicating the position in which an adaptive excitation vector is cut out. Further, parameter determination section 413 selects the fixed excitation vector that minimizes the coding distortion received as input from perceptual weighting section 412, from fixed excitation codebook 408, and outputs the fixed excitation vector code (F) indicating the selection result to fixed excitation codebook 408 and multiplexing section 414. Further, parameter determination section 413 selects the quantized adaptive excitation gain and quantized fixed excitation gain that minimize the coding distortion received as input from perceptual weighting section 412, from quantized adaptive gain generating section 407, and outputs the quantized adaptive excitation gain code (G) indicating the selection result to quantized gain generating section 407 and multiplexing section 414.

Multiplexing section 414 outputs encoding information acquired by multiplexing the quantized LSP code (L) received as input from LSP vector quantization section 403, and the adaptive excitation lag code (A), fixed excitation vector code (F) and quantization excitation gain code (G) received as input from parameter determination section 413.

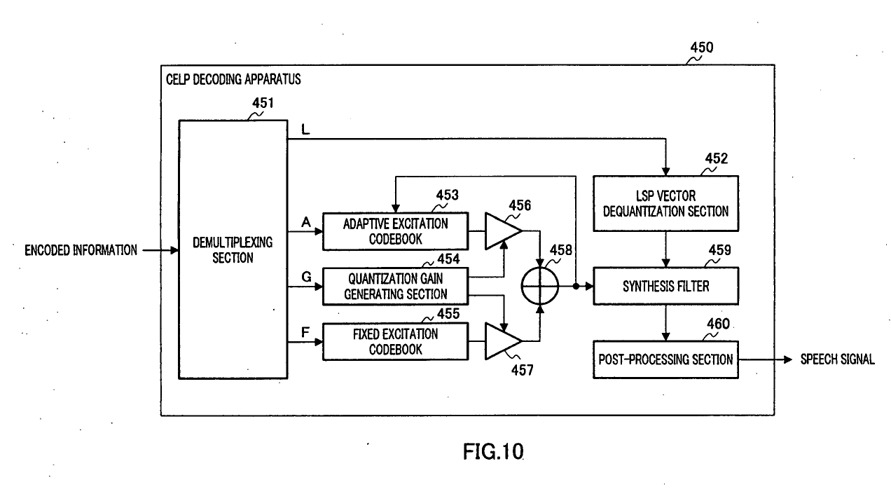

FIG. 10 is a block diagram showing main components of CELP decoding apparatus 450 according to the present embodiment.

CELP decoding apparatus 450 is provided with demultiplexing section 451, LSP vector dequantization section 452, adaptive excitation codebook 453, quantization gain generating section 454, fixed excitation codebook 455, multipliers 456 and 457, adder 458, synthesis filter 459 and post-processing section 460. Here, LSP vector dequantization section 452 is formed with LSP vector dequantization apparatus 150 according to Embodiment 1, LSP vector dequantization apparatus 250 according to Embodiment 2 or LSP vector dequantization apparatus 350 according to Embodiment 3.

Demultiplexing section 451 performs demultiplexing processing for the encoding information transmitted from CELP encoding apparatus 400 and acquires quantized LSP code (L), adaptive excitation lag code (A), quantized excitation gain code (G) and fixed excitation vector code (F). Demultiplexing section 451 outputs the quantized LSP code (L) to LSP vector dequantization section 452, the adaptive excitation lag code (A) to adaptive excitation codebook 453, the quantized excitation gain code (G) to quantization gain generating section 454, and the fixed excitation vector code (F) to fixed excitation codebook 455.

LSP vector dequantization section 452 decodes a quantized LSP vector from the quantized LSP code (L) received as input from demultiplexing section 451, and outputs the quantized LSP vector to synthesis filter 459.

Adaptive excitation codebook 453 cuts out one frame of samples in the buffer from the cut position specified by the adaptive excitation lag code (A) received as input from demultiplexing section 451, and outputs the cut vector to multiplier 456 as an adaptive excitation vector. Here, adaptive excitation codebook 453 updates the buffer every time an excitation is received as input from adder 458.

Quantization gain generating section 454 decodes the quantized adaptive excitation gain and quantized fixed excitation gain specified by the quantized excitation gain code (G) received as input from demultiplexing section 451, and outputs the quantized adaptive excitation gain to multiplier 456 and the quantized fixed excitation gain to multiplier 457.

Fixed excitation codebook 455 generates the fixed excitation vector specified by the fixed excitation vector code (F) received as input from demultiplexing section 451, and outputs the fixed excitation vector to multiplier 457.

Multiplier 456 multiplies the adaptive excitation vector received as input from adaptive excitation codebook 453 by the quantized adaptive excitation gain received as input from quantization gain generating section 454, and outputs the result to adder 458.

Multiplier 457 multiplies the fixed excitation vector received as input from fixed excitation codebook 455 by the quantized fixed excitation gain received as input from quantization gain generating section 454, and outputs the result to adder 458.

Adder 458 generates an excitation by adding the adaptive excitation vector after gain multiplication received as input from multiplier 456 and the fixed excitation vector after gain multiplication received as input from multiplier 457, and outputs this generated excitation to synthesis filter 459 and adaptive excitation codebook 453. Here, the excitation inputted in adaptive excitation codebook 453 is stored in the buffer of adaptive excitation codebook 453.

Synthesis filter 459 performs synthesis processing using the excitation received as input from adder 458 and the filter coefficients decoded in LSP vector dequantization section 452, and outputs the generated synthesis signal to post-processing section 460.

Post-processing section 460 processes the synthesis signal received as input from synthesis filter 459 by performing processing to improve the subjective quality of speech, such as format enhancement and pitch enhancement, and processing to improve the subjective quality of stationary noise, and outputs the resulting speech signal.

As described above, according to the present invention, by adaptively adjusting the vector space of second code vectors for second quantization using an additive factor and scaling factor associated with the quantization result in first quantization, and by applying an LSP vector quantization apparatus that performs multi-stage quantization processing to an CELP encoding apparatus, it is possible to improve the accuracy of speech encoding with a smaller amount of calculations and lower bit rate.

As described above, embodiments of the present invention have been explained above.

Further, LSP can be referred to as LSF (Line Spectral Frequency), and it is possible to read LSP as LSF. Further, when ISP (Immittance. Spectrum Pairs) is quantized as a spectrum parameter instead of LSP, it is possible to read LSP as ISP and utilize an ISP quantization/dequantization apparatus in the present embodiments.

The vector quantization apparatus, vector dequantization apparatus and vector quantization and dequantization methods of the present invention are not limited to the embodiments described above, and can be implemented with various changes.

For example, although a case has been described with the above-described embodiments where a speech signal is targeted in the vector quantization apparatus, vector dequantization apparatus and vector quantization and dequantization methods, it is equally possible to apply the present invention to an audio signal and such.

The vector quantization apparatus and vector dequantization apparatus according to the present invention can be mounted on a communication terminal apparatus in a mobile communication system that transmits speech, audio and such, so that it is possible to provide a communication terminal apparatus having the same operational effect as above.

Although a case has been described with the above embodiments as an example where the present invention is implemented with hardware, the present invention can be implemented with software. For example, by describing the vector quantization method and vector dequantization method according, to the present invention in a programming language, storing this program in a memory and making the information processing section execute this program, it is possible to implement the same function as the vector quantization apparatus and vector dequantization apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array), or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-283097, filed on Oct. 17, 2006, including the specification, drawings and abstract, is included herein by reference in its entirety.

### INDUSTRIAL APPLICABILITY

The vector quantization apparatus, vector dequantization apparatus and vector quantization and dequantization methods according to the present invention are applicable for, for example, speech coding and speech decoding.

1. A vector quantization apparatus comprising:
a first quantization section that comprises a first codebook, quantizes an input vector to generate a first code and first quantization vector;
a quantization residual generating section that generates a residual between the vector and the first quantization vector, as a quantization residual vector;
an additive factor selecting section that comprises an additive factor codebook and selects an additive factor vector associated with the first code from the additive factor codebook;
an additive residual generating section that generates a residual between the first quantization vector and the additive factor vector, as an additive residual vector; and
a second quantization section that comprises a second codebook, quantizes the additive residual vector to generate a second code.

2. The vector quantization apparatus according to claim 1, wherein:
the first codebook comprises a plurality of first code vectors;
the first quantization section selects, as the first quantization vector, a first code vector that is the most similar to the vector from the first codebook and uses an index of the selected first code vector as the first code;
the additive factor codebook comprises a plurality of additive factor code vectors;
the additive factor selecting section selects, as the additive factor vector, an additive factor code vector that is the most similar to the first quantization residual vector from the additive factor codebook;
the second codebook comprises a plurality of second code vectors; and
the second quantization section selects a second code vector that is the most similar to the additive residual vector from the second codebook and uses an index of the selected second code vector as the second code.

3. The vector quantization apparatus according to claim 2, further comprising a scaling factor selecting section that comprises a scaling factor table comprising a plurality of scaling factors and selects a scaling factor associated with the first code from the scaling factor table,
wherein, using the plurality of second code vectors multiplied by the selected scaling factor, the second quantization section calculates similarities with respect to the additive residual vector.

4. The vector quantization apparatus according to claim 2, further comprising:
a vector split section that splits the quantization residual vector into a first split vector and second split vector;
a first split quantization section that comprises a first split codebook and quantizes the first split vector;
a second split quantization section that comprises a second split codebook and quantizes the second split vector;
a split additive factor selecting section that selects an additive factor used in the second split quantization section, using a quantization result in the first split quantization section.

5. A vector dequantization apparatus comprising:
a first dequantization section that comprises a first codebook, dequantizes a first code acquired from a received quantized vector code to generate a first quantization vector;
a second dequantization section that comprises a second codebook, dequantizes a second code acquired from the quantized vector code to generate a quantization additive residual vector;
an additive factor selecting section that comprises an additive factor codebook and selects an additive factor vector associated with the first code from the additive factor codebook;
a quantization residual generating section that generates a quantization residual vector by adding the quantization additive residual vector and the additive factor vector; and
a quantization vector generating section that generates a quantized vector by adding the first vector and the quantization residual vector.

6. A vector quantization method comprising the steps of:
with a first codebook, quantizing an input vector to generate a first code and first quantization vector;
generating a residual between the vector and the first quantization vector, as a quantization residual vector;
with an additive factor codebook, selecting an additive factor vector associated with the first code from the additive factor codebook;
generating a residual between the first quantization vector and the additive factor vector, as an additive residual vector; and
with a second codebook, quantizing the additive residual vector to generate a second code.

7. A vector dequantization method comprising the steps of:
with a first codebook, dequantizing a first code acquired from a received quantized vector code to generate a first quantization vector;
with a second codebook, dequantizing a second code acquired from the quantized vector code to generate a quantization additive residual vector;
with an additive factor codebook, selecting an additive factor vector associated with the first code from the additive factor codebook;
generating a quantization residual vector by adding the quantization additive residual vector and the additive factor vector; and
generating a quantized vector by adding the first quantization vector and the quantization residual vector.

8. A CELP encoding apparatus comprising the vector quantization apparatus according to claim 1.

9. A CELP decoding apparatus comprising the vector dequantization apparatus according to claim 5.
